(19) United States
(12) Patent Application Publication
(10) Pub. No.: US 2017/0302192 A1
(43) Pub. Date: Oct. 19, 2017

(54) ELECTRICAL ARRANGEMENT AND METHOD FOR GENERATING A DIRECT CURRENT

(71) Applicant: SIEMENS AKTIENGESELLSCHAFT, MUNICH (DE)

(72) Inventors: WOLFGANG HOERGER, HAUSEN (DE); MARTIN PIESCHEL, NUERNBERG (DE)

(21) Appl. No.: 15/513,851

(22) PCT Filed: Sep. 24, 2014
(86) PCT No.: PCT/EP2014/070365

§ 371 Date: Mar. 23, 2017

(51) Int. Cl. H02M 7/217; H05B 7/00; H02M 7/06; H05B 7/18; H02M 1/14

(52) U.S. Cl. CPC H02M 7/217; H05B 7/18; H02M 1/143; H02M 7/06; H05B 7/005

(57) ABSTRACT

A rectifier arrangement includes at least one input alternating voltage terminal to which an alternating current can be supplied, at least two output direct voltage terminals at which direct current can be tapped and at least one series circuit with at least two sub-modules connected in series. Each sub-module of the series circuit includes at least one converter module, an inverter module and a transformer module. Each sub-module of the series circuit additionally includes a rectifier module. The outputs of the rectifier modules are connected in parallel and form the output direct voltage terminals of the rectifier arrangement.

The invention relates to an arrangement having at least one input alternating voltage terminal into which an alternating current can be fed and at least two output terminals, as well as to a method for generating direct current.

A corresponding arrangement is described in the international patent application WO 2012/152619A2. The known arrangement is a converter arrangement comprising at least one series circuit with at least two sub-modules connected in series. The sub-modules of the series circuit each comprise at least one converter module, an inverter module and a transformer module. The known converter arrangement works as a kind of energy distribution installation, and is used to distribute electrical energy. The sub-modules of the known converter arrangement are spatially distributed for this purpose, for example over an entire urban area; they form local tapping and/or feed-in sites of the energy distribution installation for tapping and/or feeding in electrical energy. The terminals for feeding in and for tapping electrical energy are formed by the transformer modules of the sub-modules.

The invention addresses the object of providing an arrangement for generating direct current that is particularly well suited to the supply of high-powered consumers such as, for example, arc furnaces.

This object is achieved according to the invention by an arrangement with the features as claimed in patent claim 1. Advantageous embodiments of the arrangement according to the invention are specified in dependent claims.

It is accordingly provided according to the invention that the arrangement is a rectifier arrangement and the output terminals form output direct voltage terminals of the rectifier arrangement at which terminals direct current can be tapped, the sub-modules of the series circuit each additionally comprise a rectifier module, and the outputs of the rectifier modules are connected in parallel and form the output direct voltage terminals of the rectifier arrangement.

A significant advantage of the rectifier arrangement according to the invention is to be seen in the fact that as a result of the modularity, or as a result of the modular structure, the rectifier arrangement can be scaled to any desired degree with regard to the achievable electrical power output; it is only necessary to adjust the number of sub-modules connected in series to the particular power output that is required.

It is deemed to be particularly advantageous if the rectifier arrangement is multi-phase and comprises a plurality of, at least two, input alternating voltage terminals, into each of which a phase current of a multi-phase input alternating current can be fed, wherein each phase of the rectifier arrangement comprises at least one series circuit with at least two sub-modules connected in series, wherein the sub-modules of the series circuits each comprise at least one converter module, an inverter module, a transformer module and a rectifier module, and wherein the outputs of the rectifier modules of each of the series circuits are each connected in parallel and form the output direct voltage terminals of the rectifier arrangement.

The rectifier arrangement is preferably three-phase. The three input alternating voltage terminals of the rectifier arrangement preferably electrically form a delta circuit or a star circuit.

Alternatively, it can be provided that the rectifier arrangement is three-phase, and six series circuits each with at least two sub-modules connected in series form a three-phase bridge circuit.

With respect to the construction of the sub-modules, it is deemed advantageous if at least one of the rectifier modules, in particular all of the rectifier modules, comprise(s) a bridge circuit composed of four diodes.

With a view to a reduction or suppression of harmonic oscillations, or for smoothing the direct current, it is deemed advantageous if at least one of the rectifier modules, in particular all of the rectifier modules, comprise(s) a fifth diode, which is connected in parallel with the bridge circuit. Advantageously the fifth diode is a Schottky diode or a silicon carbide diode.

Alternatively or in addition, an inductor can be connected between at least one of the output terminals of at least one of the rectifier modules, in particular of all of the rectifier modules, and the diodes of the respective rectifier module to smooth the direct current.

With respect to the construction of the inverter modules, it is deemed advantageous if at least one of the inverter modules, preferably all of the inverter modules, comprise(s) in each case one series circuit composed of at least two capacitors and, connected in parallel with that, a series circuit composed of at least two switching elements connected in series. Particularly preferably, the electrical center connection between the two capacitors forms one of the output terminals of the inverter module, and the electrical center connection between the two switching elements forms another of the output terminals of the inverter module.

Alternatively, the converter modules can each comprise four switching elements connected in an H-bridge circuit.

With respect to the construction of the inverter modules, it is deemed advantageous if at least one of the inverter modules, preferably all of the inverter modules, is/are connected to a drive circuit which drives the inverter modules and which is designed such that the output voltage formed at output alternating voltage terminals exhibits a different frequency from that of the input voltage applied to the input alternating voltage terminals. Preferably the frequency of the output voltage formed at the output alternating voltage terminals is higher than the frequency of the input voltage applied to the input alternating voltage terminals. The frequency of the output voltage formed at the output alternating voltage terminals is preferably in the range between 200 and 500 Hz.

The drive circuit is preferably designed such that it performs the drive of the inverter modules with a time offset. Through a time offset, current distortions on the rectifier side, or current variations in the generated direct current, can be minimized.

With respect to the transformer module or modules, it is deemed advantageous if their transformation ratio is less than 1, i.e. if the transformer modules bring about a reduction in the voltage.

The switching elements mentioned above are preferably formed by semiconductor switches (e.g. IGBT semiconductor switches, GTO semiconductor switches or MOSFET semiconductor switches).

The invention furthermore relates to an arrangement with a rectifier arrangement. It is provided according to the invention that the rectifier arrangement is designed as described above, i.e. according to the invention, and that an arc furnace is connected to the output direct voltage terminals of the rectifier arrangement.

In the rectifier arrangement according to the invention, the power output can be specifically adjusted through the choice of the number of sub-modules (power scaling through choice of the number of sub-modules).

The invention furthermore relates to a method for generating at least one output direct current with a rectifier arrangement, which incorporates at least one input alternating voltage terminal into which an alternating current can be fed, and two output direct voltage terminals at which direct current can be tapped.

According to the invention, it is provided with respect to such a method that the rectifier arrangement comprises at least one series circuit with at least two sub-modules connected in series, each of which comprises at least one converter module, an inverter module, a transformer module and a rectifier module, and the output direct current is formed through addition of the rectifier module currents delivered at the outputs of the rectifier modules.

With respect to the advantages of the method according to the invention, we refer to the explanations provided above in connection with the arrangement according to the invention.

The inverter modules are preferably operated unidirectionally.

The inverter modules are preferably driven with an offset in time. Through a time offset, current distortions on the rectifier side, or current variations in the generated direct current, can be minimized.

In the rectifier modules, the respective output voltage of a bridge circuit, composed of four diodes, of the respective rectifier module is smoothed with a fifth diode.

Additionally or as an alternative, a smoothing of the output voltage of the rectifier modules is achieved in an advantageous manner by means of a respective inductor which is connected between one of the output terminals of the respective rectifier module and the diodes of the respective rectifier module.

Preferably, with the transformer modules, the voltage is lowered in the direction of the respective output alternating voltage terminals of the respective transformer module.

The invention is explained below in more detail with reference to exemplary embodiments; by way of example here

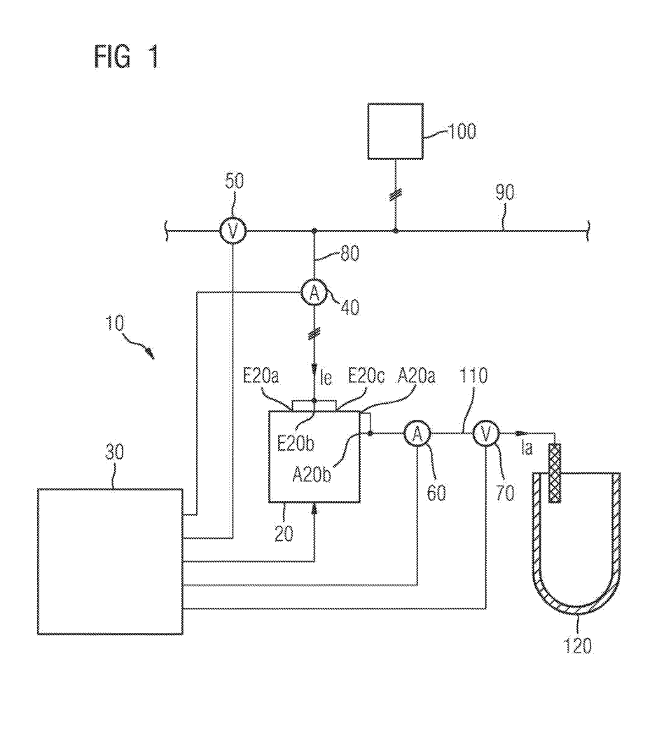

FIG. 1 shows an exemplary embodiment of a rectifier arrangement according to the invention to which an electrical load is connected,

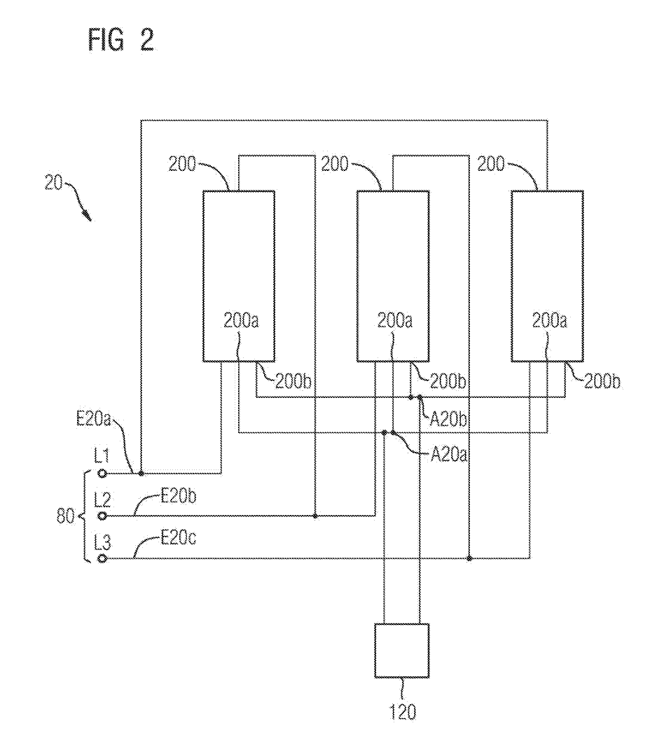

FIG. 2 shows an exemplary embodiment of a rectifier apparatus that can be employed in the rectifier arrangement according to FIG. 1, and which comprises a delta circuit,

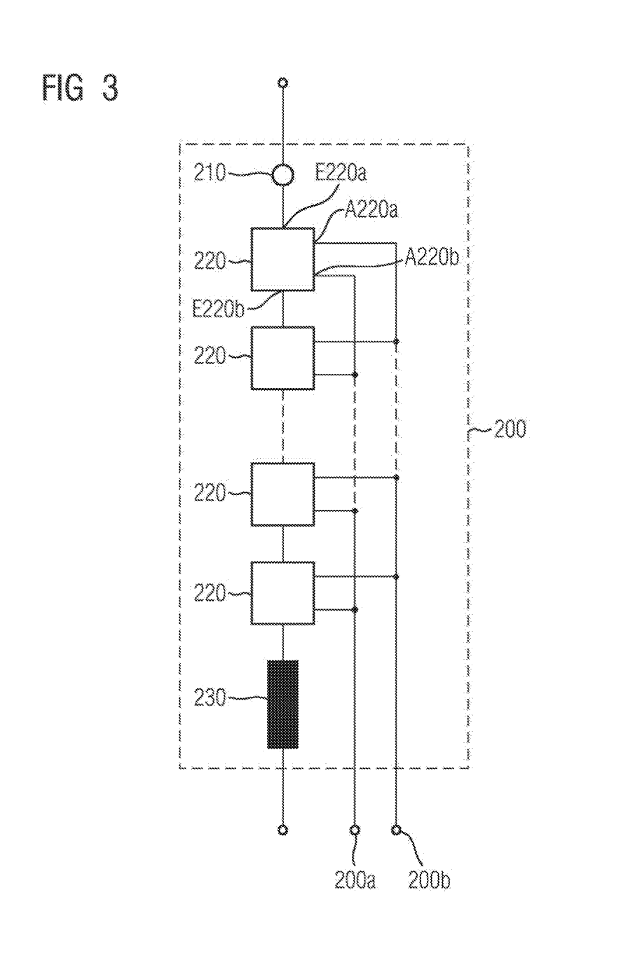

FIG. 3 shows an exemplary embodiment of a series circuit comprising a plurality of sub-modules, which circuit can be employed in the rectifier apparatus according to FIG. 2,

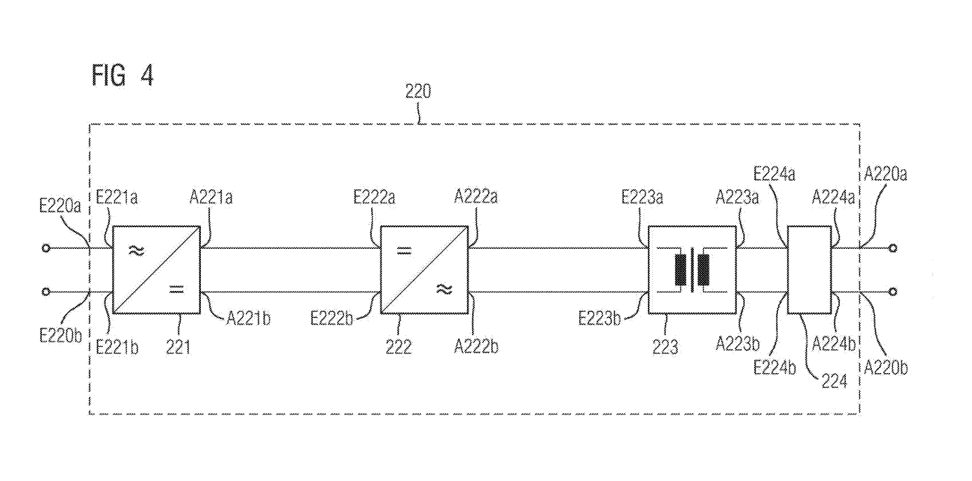

FIG. 4 shows an exemplary embodiment of a sub-module that can be employed in the series circuit according to FIG. 3,

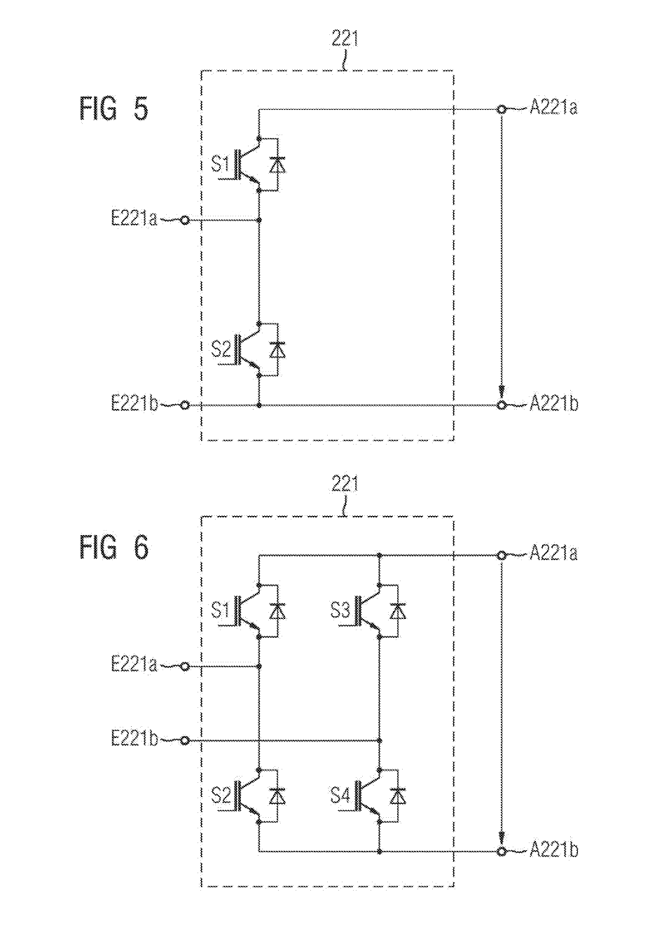

FIG. 5 shows an exemplary embodiment of a converter module that can be employed in the sub-module according to FIG. 4,

FIG. 6 shows a further exemplary embodiment of a s converter module that can be employed in the sub-module according to FIG. 4,

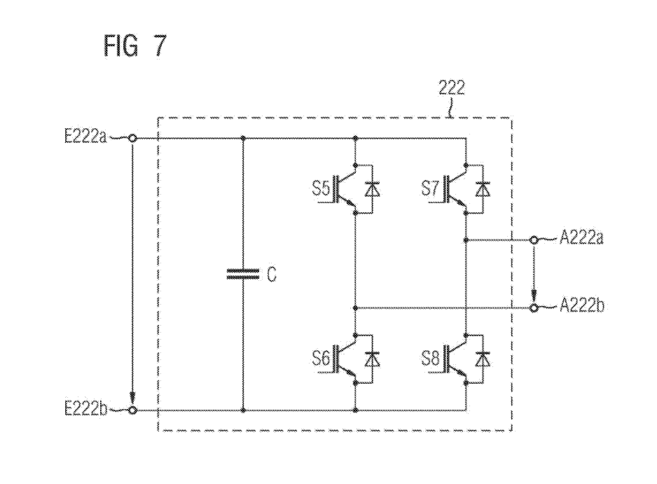

FIG. 7 shows an exemplary embodiment of an inverter module that can be employed in the sub-module according to FIG. 4,

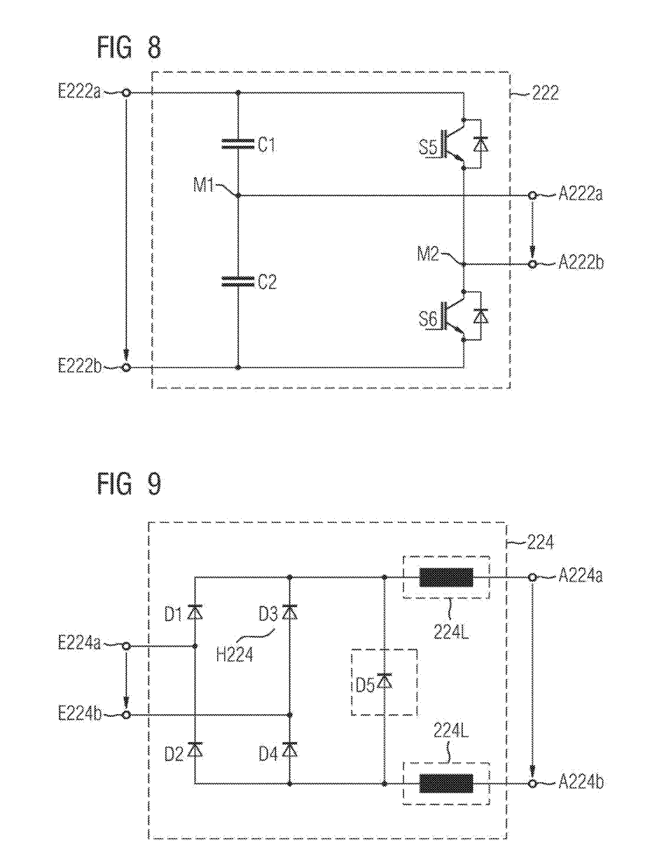

FIG. 8 shows a further exemplary embodiment of an inverter module that can be employed in the sub-module according to FIG. 4,

FIG. 9 shows an exemplary embodiment of a rectifier module that can be employed in the sub-module according to FIG. 4,

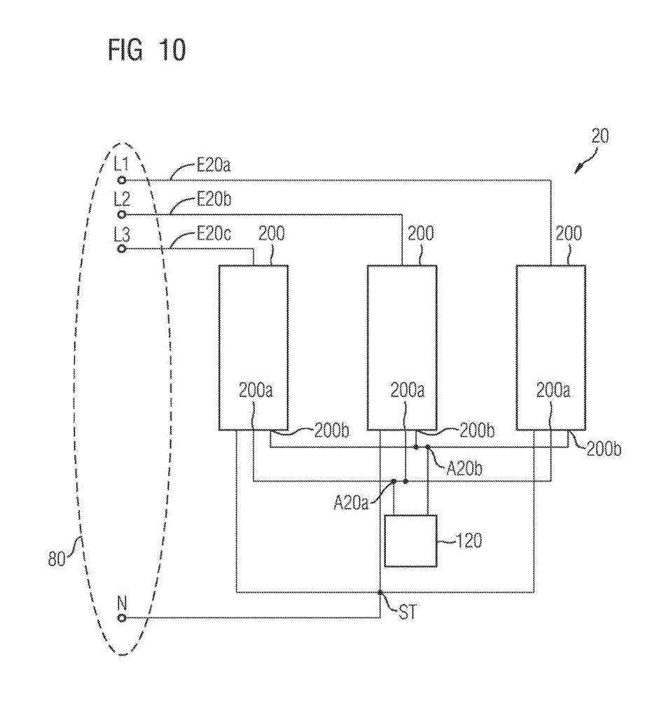

FIG. 10 shows an exemplary embodiment of a rectifier apparatus that can be employed in the rectifier arrangement according to FIG. 1, and that comprises a star circuit,

FIG. 11 shows an exemplary embodiment of a rectifier apparatus that can be employed in the rectifier arrangement according to FIG. 1, and that comprises a bridge circuit, wherein two electrical loads are connected to the rectifier apparatus,

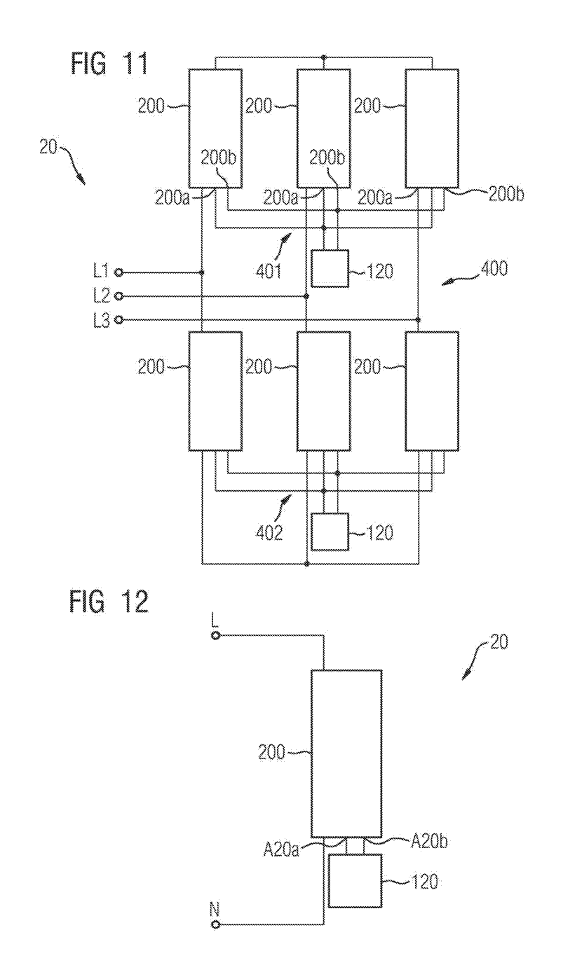

FIG. 12 shows an exemplary embodiment of a single-phase rectifier apparatus that can be employed in a single-phase rectifier arrangement,

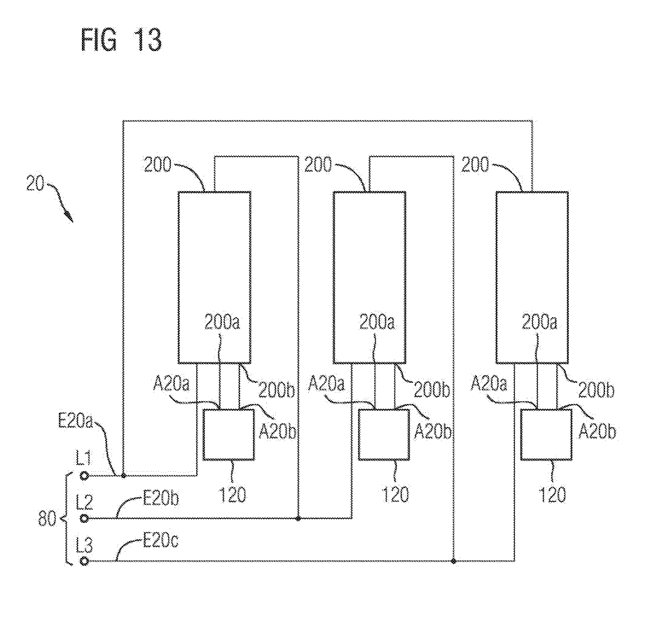

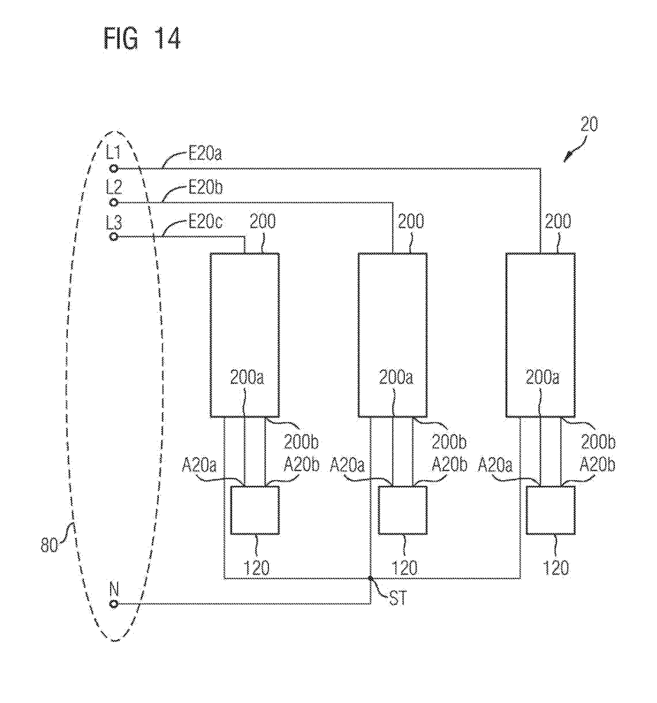

FIG. 13 shows an exemplary embodiment of a rectifier apparatus that comprises a delta circuit and is connected to the plurality of loads, and

FIG. 14 shows an exemplary embodiment of a rectifier apparatus that comprises a star circuit and is connected to the plurality of loads.

For the sake of a clear overview, the same reference signs have in all cases been used in the figures for identical or comparable components.

FIG. 1 shows a rectifier arrangement 10 that comprises a rectifier apparatus 20, a drive circuit 30, a current sensor 40 and a voltage sensor 50 on the input side of the rectifier arrangement 10, and a current sensor 60 as well as a voltage sensor 70 on the output side of the rectifier arrangement 10.

The rectifier apparatus 20 comprises three input alternating voltage terminals E20a, E20b and E20c, which are connected to a three-phase electrical cable 80. The rectifier apparatus 20 is connected via the three-phase cable 80 to a terminal rail 90 and to an energy distribution network 100 which is only shown schematically.

On the output side, the rectifier apparatus 20 comprises two output direct voltage terminals A20a and A20b, through which the output side of the rectifier apparatus 20 is connected to an electrical direct current cable 110 and, through this, to a direct current load 120 in the form of an arc furnace.

The rectifier arrangement 10 according to FIG. 1 can, for example, be operated as follows:

By means of the current sensor 40, the drive circuit 30 measures the three-phase input alternating current Ie flowing into the rectifier apparatus 20 at the input side, and, with the voltage sensor 50, the drive circuit 30 measures the three-phase input voltage applied to the rectifier apparatus 20. In addition to this, the drive circuit 30 uses the current sensor 60 and the voltage sensor 70 to measure the output direct current Ia delivered by the rectifier apparatus 20, as well as the output direct voltage provided at the output side.

With the aid of the measured values, the drive circuit 30 determines an optimum drive of the rectifier apparatus 20 in such a way that the output direct current Ia has optimum characteristics for the operation of the direct current load 120.

FIG. 2 shows an exemplary embodiment of a rectifier apparatus 20 that can be employed in the rectifier arrangement 10 according to FIG. 1. The three input alternating voltage terminals E20a, E20b and E20c, which are connected to the three-phase cable 80 according to FIG. 1 can be seen. The three phases of the three-phase cable 80 are marked in FIG. 2 with reference signs L1, L2 and L3.

The rectifier apparatus 20 comprises three delta-connected series circuits 200, whose series-connected components are not shown in more detail in FIG. 2 for the sake of clarity. The three delta-connected series circuits 200, i.e. the delta circuit formed by the series circuits 200, is connected via the output direct voltage terminals A20a and A20b of the rectifier apparatus 20 to an external electrical load, for example the direct current load 120 according to FIG. 1. The output terminals 200a and 200b of the series circuits 200 are connected in parallel for this purpose.

Alternatively, in each case an individual direct current load 120 can be connected to each of the series circuits 200 (cf. FIG. 13). In such a case, the output terminals 200a and 200b of each series circuit 200 each form two series-circuit-specific output direct voltage terminals A20a and A20b of the rectifier apparatus 20.

FIG. 3 shows an exemplary embodiment of a series circuit 200 that can be employed in the rectifier apparatus 20 according to FIG. 2. The series circuit 200 according to FIG. 3 comprises a current sensor 210 preferably connected to the drive circuit 30 according to FIG. 1, a large number of sub-modules 220, and an inductor 230. The current sensor 210, the sub-modules 220 and the inductor 230 are connected electrically in series. The series connection of the sub-modules 220 is made via their input terminals E220a and E220b.

Each of the sub-modules 220 comprises two output terminals A220a and A220b. The output terminals A220a and A220b of the sub-modules 220 are connected in parallel, and form the two output terminals 200a and 200b, which—as FIG. 2 shows—each form one of the respective output direct voltage terminals A20a and A20b of the rectifier apparatus 20 according to FIG. 2 or FIG. 1.

FIG. 4 shows an exemplary embodiment of a sub-module 220 that can be employed in the series circuit 200 according to FIG. 3. The sub-module 220 comprises a converter module 221, an inverter module 222, a transformer module 223 and a rectifier module 224. The converter module 221, the inverter module 222, the transformer module 223 and the rectifier module 224 are cascaded after one another. This means that the outputs A221a and A221b of the converter module 221 are connected to the inputs E222a and E222b of the inverter module 222, the outputs A222a and A222b of the inverter module 222 are connected to the inputs E223a and E223b of the transformer module 223, and the outputs A223a and A223b of the transformer module 223 are connected to the inputs E224a and E224b of the rectifier module 224. The inputs E221a and E221b of the converter module 221 according to FIG. 4 form the inputs E220a and E220b of the sub-module 220, which, in order to form the series circuit of the sub-modules 220 (cf. FIG. 3) are connected in series with the inputs E221a and E221b of converter modules 221 of upstream and downstream sub-modules 220 (cf. FIG. 3).

The outputs 224a and 224b of the rectifier modules 224 in the sub-modules 220 of the series circuit 200 are connected on the output side in parallel according to FIG. 3 in order to form the output terminals 200a and 200b according to FIG. 3.

FIG. 5 shows an exemplary embodiment of a converter module 221 that can be employed in the sub-module 220 according to FIG. 4. The converter module 221 comprises two switching elements S1 and S2, a diode being connected in parallel with each of these. The switching elements S1 and S2 can, for example, be semiconductor switches, for example in the form of transistors. The outputs of the converter module 221 are identified in FIGS. 4 and 5 with the reference signs A221a and A221b, and are connected to the inputs E222a and E222b of the downstream inverter module 222.

The drive of the switching elements S1 and S2 of the converter module 221 is preferably performed by the drive circuit 30 according to FIG. 1, depending on the current and voltage values that the two current sensors 40 and 60, the two voltage sensors 50 and 70 and the current sensors 210 of the series circuits 200 provide to the drive circuit 30.

FIG. 6 shows a further exemplary embodiment of a converter module 221 that can be employed in the sub-module 220 according to FIG. 4. The converter module 221 comprises four switching elements S1, S2, S3 and S4, a diode being connected in parallel with each of these. The four switching elements S1 to S4 are connected in the form of an H-bridge circuit, and are preferably driven by the drive circuit 30 according to FIG. 1, depending on the current and voltage values that are supplied by the two current sensors 40 and 60, the two voltage sensors 50 and 70 and the current sensors 210 of the series circuits 200. The outputs of the converter module 221 are identified in FIGS. 4 and 6 with the reference signs A221a and A221b, and are connected to the inputs E222a and E222b of the downstream inverter module 222.

FIG. 7 shows an exemplary embodiment of an inverter module 222 that can be employed in the sub-module 220 according to FIG. 4. The inverter module 222 according to FIG. 7 comprises four switching elements S5, S6, S7 and S8, a diode being connected in parallel with each of these. The four switching elements S5, S6, S7 and S8 are connected in the form of an H-bridge circuit, whose outputs form the outputs A222a and A222b of the inverter module 222.

A capacitor C, which forms the input terminals E222a and E222b of the inverter module 222 that are connected to the upstream converter module 221 (cf. FIG. 4), is connected in parallel with the H-bridge circuit.

The output terminals A222a and A222b of the inverter module 222 are connected to the input terminals E223a and E223b of the downstream transformer module 223 (cf. FIG. 4).

The drive of the four switching elements S5, S6, S7 and S8 is preferably provided by the drive circuit 30 according to FIG. 1, depending on the measured values that are supplied by the two current sensors 40 and 60, the two voltage sensors 50 and 70 and the current sensors 210 of the series circuits 200.

FIG. 8 shows a further exemplary embodiment of an inverter module 222 that can be employed in the sub-module 220 according to FIG. 4. The inverter module 222 comprises two switching elements S5 and S6 connected in series, a diode being connected in parallel with each of these, along with two capacitors C1 and C2 connected in series.

The center terminal M1 between the two capacitors C1 and C2 connected in series forms one of the two output terminals A222a of the inverter module 222. The center terminal M2 between the two switching elements S5 and S6 connected in series forms the other of the two output terminals A222b of the inverter module 222.

The drive of the two switching elements S5 and S6 is preferably provided by the drive circuit 30 according to FIG. 1, depending on the measured values that are supplied by the two current sensors 40 and 60, the two voltage sensors 50 and 70 and the current sensors 210 of the series circuits 200.

The inverter module 222 according to FIG. 8 advantageously comprises fewer switching elements than the inverter module 222 according to FIG. 7, and permits a unidirectional flow of power from left to right in FIG. 8. The inverter module 222 according to FIG. 7 permits—due to the two additional switching elements—a bidirectional flow of power both from left to right as well as from right to left in FIG. 7.

FIG. 9 shows an exemplary embodiment of a rectifier module 224 that can be employed in the sub-module 220 according to FIG. 4. The rectifier module 224 comprises an H-bridge circuit H224 composed of four diodes D1 to D4, with a fifth diode D5 being connected in parallel to said H-bridge circuit. The fifth diode D5 is preferably a particularly fast-switching diode, particularly preferably a Schottky diode or a silicon carbide diode.

An inductor 224L is preferably connected in series between one of the two output terminals A224a of the rectifier module 224 and one of two terminals of the fifth diode D5 in order to smooth the current. Alternatively or in addition, an inductor 224L can be connected in series between the other of the two output terminals A224b of the rectifier module 224 and the other of the two terminals of the fifth diode D5 in order to smooth the current.

FIG. 10 shows a further exemplary embodiment of a rectifier apparatus 20 that can be employed in the rectifier arrangement 10 according to FIG. 1. In contrast to the exemplary embodiment according to FIG. 2, the series circuits 200 of the rectifier apparatus 20 are not delta-connected, but are star-connected to form a star circuit. The star node formed by the interconnection is identified in FIG. 10 by reference sign ST. A return line N, for example the return line of the three-phase cable 80 according to FIG. 1, can be connected to the star node ST.

The three star-connected series circuits 200, or the star circuit formed by the series circuits 200, is/are connected via the output direct voltage terminals A20a and A20b of the rectifier apparatus 20 to an external electrical load, for example the direct current load 120 according to FIG. 1. The output terminals 200a and 200b of the series circuits 200 are connected in parallel for this purpose.

Alternatively, in each case an individual direct current load 120 can be connected to each of the series circuits 200 (cf. FIG. 14). In such a case, the output terminals 200a and 200b of each series circuit 200 each form two series-circuit-specific output direct voltage terminals A20a and A20b of the rectifier apparatus 20.

For reasons of clarity, the construction of the series circuits 200 is not shown in more detail in FIGS. 10 and 14. The series circuits 200 can, for example, correspond to the series circuits 200 of the rectifier apparatus 20 according to FIG. 2, or can be constructed as has been explained by way of example above in detail in connection with FIGS. 3 to 9. The above explanations thus apply correspondingly to the construction of the series circuits 200 according to FIGS. 10 and 14.

FIG. 11 shows an exemplary embodiment of a rectifier apparatus 20 in which series circuits 200, which each comprise at least two sub-modules connected in series but, for the sake of clarity, not illustrated in FIG. 11, form a bridge circuit 400. The outputs 401 and 402 of the bridge circuit 400 form output direct voltage terminals of the rectifier apparatus 20, to which electrical loads, such as for example the direct current load 120 or the arc furnace according to FIG. 1, can be connected. Alternatively, the outputs 401 and 402 of the bridge circuit 400 can also be connected in parallel, and together form the output direct voltage terminals A20a and A20b (cf. FIG. 1) of the rectifier apparatus 20.

The construction of the series circuits 200 of the rectifier apparatus 20 can, for example, correspond to the construction of the series circuits 200, as has been explained above in detail in connection with FIGS. 2 to 9.

FIG. 12 shows an exemplary embodiment of a single-phase rectifier apparatus 20, which comprises a series circuit with a large number of sub-modules connected in series, but, for reasons of clarity, not further illustrated in FIG. 12. The output terminals of the sub-modules of the series circuit 200 are connected in parallel, and form output direct voltage terminals A20a and A20b of the rectifier apparatus 20, to which a direct current load 120 can be connected. The series circuit 200 of the rectifier apparatus 20 according to FIG. 12 can correspond in its construction to the series circuits 200 as have been explained above in detail in connection with FIGS. 2 to 9.

Although the invention has been more closely illustrated and described in detail through preferred exemplary embodiments, the invention is not restricted by the disclosed examples, and other variations can be derived from this by the expert without going beyond the scope of protection of the invention.

### LIST OF REFERENCE SIGNS

10 Rectifier arrangement
20 Rectifier apparatus
30 Drive circuit
40 Current sensor
50 Voltage sensor
60 Current sensor
70 Voltage sensor
80 Electrical cable
90 Terminal rail
100 Energy distribution network
110 Electrical direct current cable
120 Direct current load
200 Series circuit
200a Output terminal
200b Output terminal
210 Current sensor
220 Sub-modules
221 Converter module
222 Inverter module
223 Transformer module
224 Rectifier module
224L Inductor
230 Inductor
400 Bridge circuit
401 Output
402 Output
A20a Output direct voltage terminal
A20b Output direct voltage terminal
A220a Output terminal of the sub-module
A220b Output terminal of the sub-module
A221a Output terminal of the converter module
A221b Output terminal of the converter module
A222a Output terminal of the inverter module
A222b Output terminal of the inverter module
A223a Output terminal of the transformer module
A223b Output terminal of the transformer module
A224a Output terminal of the rectifier module
A224b Output terminal of the rectifier module
C Capacitor
C1 Capacitor
C2 Capacitor
D1 Diode
D2 Diode
D3 Diode
D4 Diode
D5 Diode
E20a Input alternating voltage terminal
E20b Input alternating voltage terminal
E20c Input alternating voltage terminal
E220a Input terminal of the sub-module
E220b Input terminal of the sub-module
E221a Input terminal of the converter module
E221b Input terminal of the converter module
E222a Input terminal of the inverter module
E222b Input terminal of the inverter module
E223a Input terminal of the transformer module
E223b Input terminal of the transformer module
E224a Input terminal of the rectifier module
E224b Input terminal of the rectifier module
H224 H-bridge circuit
Ia Output direct current
Ie Input alternating current
L1 Phase
L2 Phase
L3 Phase
M1 Center connection
M2 Center connection
N Return line
ST Star node
S1 Switching element
S2 Switching element
S3 Switching element
S4 Switching element
S5 Switching element
S6 Switching element
S7 Switching element
S8 Switching element

1-15. (canceled)

16. A rectifier arrangement, comprising:
at least one input alternating voltage terminal into which an alternating current can be fed;
at least two output direct voltage terminals at which direct current can be tapped; and
at least one series circuit having at least two sub-modules connected in series, said sub-modules each including at least one converter module, an inverter module, a transformer module and a rectifier module, said rectifier modules having outputs connected in parallel and forming said output direct voltage terminals.

17. The arrangement according to claim 16, which further comprises:
multiple phases;
said at least one input alternating voltage terminal including at least two input alternating voltage terminals into each of which a phase current of a multi-phase input alternating current can be fed;
said at least one series circuit including at least one series circuit with at least two sub-modules connected in series for each phase;
said sub-modules each including at least one converter module, an inverter module, a transformer module and a rectifier module; and
said outputs of said rectifier modules of each of said series circuits each being connected in parallel and forming said output direct voltage terminals.

18. The arrangement according to claim 17, wherein:
said multiple phases are three phases; and
said at least two input alternating voltage terminals are three input alternating voltage terminals electrically forming a delta circuit or a star circuit.

19. The arrangement according to claim 16, wherein:
said multiple phases are three phases; and
said series circuits include six series circuits each having at least two sub-modules connected in series to form a three-phase bridge circuit.

20. The arrangement according to claim 16, wherein at least one of said rectifier modules includes a bridge circuit having four diodes.

21. The arrangement according to claim 20, wherein at least one of said rectifier modules includes a fifth diode connected in parallel with said bridge circuit.

22. The arrangement according to claim 21, wherein said fifth diode is a Schottky diode or a silicon carbide diode.

23. The arrangement according to claim 20, which further comprises an inductor connected between at least one of said output terminals of at least one of said rectifier modules and said diodes of said rectifier module.

24. The arrangement according to claim 17, wherein:
at least one of said inverter modules includes a series circuit of at least two capacitors and a series circuit of at least two switching elements, said series circuit of said at least two switching elements being connected in parallel with said series circuit of said at least two capacitors;
said at least two capacitors having an electrical center connection therebetween forming one of said output terminals of said inverter module; and
said at least two switching elements having an electrical center connection therebetween forming another of said output terminals of said inverter module.

25. The arrangement according to claim 17, which further comprises a drive circuit connected to at least one of said inverter modules, said drive circuit driving said at least one inverter module and causing an input voltage applied to inputs of said at least one inverter module to have a different frequency than an output voltage formed at outputs of said at least one inverter module.

26. An arc furnace assembly, comprising:
an arc furnace connected to said output direct voltage terminals of said rectifier arrangement according to claim 16.

27. A method for generating at least one output direct current, the method comprising the following steps:
providing a rectifier arrangement including at least one input alternating voltage terminal into which an alternating current can be fed, two output direct voltage terminals at which direct current can be tapped, and at least one series circuit including at least two sub-modules connected in series;
providing each of the at least two sub-modules with at least one converter module, an inverter module, a transformer module and a rectifier module having an output delivering a rectifier module current; and
forming the output direct current by an addition of the rectifier module currents delivered at the outputs of the rectifier modules of the series circuit.

28. The method according to claim 27, which further comprises operating the inverter modules unidirectionally.

29. The method according to claim 27, which further comprises providing the rectifier module with a bridge circuit having four diodes and delivering an output voltage, and smoothing the output voltage of the bridge circuit with a fifth diode.

30. The method according to claim 29, which further comprises:
providing the rectifier module with output terminals;
